(19) United States
(12) Patent Application Publication
(10) Pub. No.: US 2012/0129048 A1
(43) Pub. Date: May 24, 2012

(54) BINDER FOR LITHIUM SECONDARY BATTERY, NEGATIVE ELECTRODE FOR LITHIUM SECONDARY BATTERY, LITHIUM SECONDARY BATTERY, BINDER PRECURSOR SOLUTION FOR LITHIUM SECONDARY BATTERY, AND METHOD FOR MANUFACTURING NEGATIVE ELECTRODE FOR LITHIUM SECONDARY BATTERY

(75) Inventors: Atsushi Fukui, Kobe-city (JP); Taizo Sunano, Kobe-city (JP); Maruo Kamino, Kobe-city (JP); Yoshinori Yoneda, Annaka-city (JP)

(73) Assignees: SHIN-ETSU CHEMICAL CO., LTD., Tokyo (JP); SANYO ELECTRIC CO., LTD., Moriguchi-city (JP)

(21) Appl. No.: 13/299,700

(22) Filed: Nov. 18, 2011

(30) Foreign Application Priority Data
Nov. 18, 2010 (JP) 2010-257699

(51) Int. Cl. H01M 4/62; B05D 3/02; H01M 4/04; C08G 73/10; H01B 1/12

(52) U.S. Cl. 429/217; 528/26; 252/500; 427/58

(57) ABSTRACT

Provided is a binder capable of realizing a lithium secondary battery that includes a negative electrode including a negative-electrode active material layer containing at least one of silicon and a silicon alloy as a negative-electrode active material and also containing a binder and has an excellent charge-discharge cycle characteristic. The binder for the lithium secondary battery contains a polyimide resin that is formed by imidizing either a tetracarboxylic acid or a tetracarboxylic anhydride and a diamine, the polyimide resin having a hydrolyzable silyl group.

### BACKGROUND OF THE INVENTION

1. Field of the Invention

This invention relates to binders for lithium secondary batteries, negative electrodes for lithium secondary batteries, lithium secondary batteries, binder precursor solutions for lithium secondary batteries, and methods for manufacturing negative electrodes for lithium secondary batteries. More particularly, this invention relates to a binder for a lithium secondary battery containing at least one of silicon and an silicon alloy as a negative-electrode active material, a negative electrode for a lithium secondary battery containing the binder, a lithium secondary battery including the negative electrode, a precursor solution of the binder, and a method for manufacturing the negative electrode for the lithium secondary battery.

2. Description of Related Arts

In recent years the demand for higher energy density of lithium secondary batteries has been increasing. Along with this, much research has been conducted concerning negative-electrode active materials capable of providing higher energy density than graphite materials, which have been commonly used as negative-electrode active materials in the past. An example of such a negative-electrode active material is an alloying material containing Al, Sn, Si, or like element and capable of alloying with lithium.

The alloying material containing Al, Sn, Si, or like element and capable of alloying with lithium is a negative-electrode active material capable of storing lithium by an alloying reaction with lithium, and it has a larger capacity per volume than graphite materials Therefore, by using as a negative-electrode active material an alloying material containing Al, Sn, Si, or like element and capable of alloying with lithium, a lithium secondary battery with a high energy density can be provided.

However, in a negative electrode employing as a negative-electrode active material an alloying material containing Al, Sn, Si, or like element and capable of alloying with lithium, the negative-electrode active material undergoes large volume changes during charge and discharge, i.e., during lithium storage and release. Therefore, the negative-electrode active material is likely to be pulverized and the negative-electrode active material layer is likely to be peeled from the current collector. If the pulverization of the negative-electrode active material or the peeling of the negative-electrode active material layer from the negative-electrode current collector occurs, the current collecting performance in the negative electrode will be degraded, resulting in a deteriorated charge-discharge cycle characteristic of the lithium secondary battery.

In relation to this problem, JP-A-2002-260637 proposes a method in which a mixture layer containing a polyimide binder and active material particles containing at least one of silicon and a silicon alloy is formed on a current collector and the layer is sintered in a non-oxidizing atmosphere. The literature describes that use of a negative electrode obtained by the above method provides a good cycle characteristic.

WO2004/004031A1, JP-A-2007-242405, and JP-A-2008-34352 propose to optimize a negative electrode binder contained in a negative-electrode active material layer, thereby obtaining a good cycle characteristic. Specifically, W02004/004031A1 proposes to use as the negative electrode binder a polyimide having predetermined mechanical properties. JP-A-2007-242405 proposes to use as the negative electrode binder an imide compound obtained by decomposing a binder precursor composed of a polyimide or a polyamic acid by a heat treatment. JP-A-2008-34352 proposes to use as the negative electrode binder a polyimide composed of 3,3′,4,4′-benzophenonetetracarboxylic dianhydride and either m-phenylenediamine or 4,4′-diaminodiphenylmethane.

However, there is a demand to further enhance the charge-discharge cycle characteristic of lithium secondary batteries.

### SUMMARY OF THE INVENTION

The present invention has been made in view of the foregoing points, and its object is to provide a binder capable of realizing a lithium secondary battery that includes a negative electrode including a negative-electrode active material layer containing at least one of silicon and a silicon alloy as a negative-electrode active material and also containing a binder and has an excellent charge-discharge cycle characteristic.

A binder for a lithium secondary battery according to the present invention contains a polyimide resin formed by imidizing either a tetracarboxylic acid or a tetracarboxylic anhydride and a diamine, the polyimide resin having a hydrolyzable silyl group.

In a particular aspect of the binder for the lithium secondary battery according to the present invention, the hydrolyzable silyl group is an alkoxysilyl group.

In another particular aspect of the binder for the lithium secondary battery according to the present invention, the polyimide resin is a resin formed by imidizing a tetracarboxylic anhydride, a diamine, and a silane coupling agent. The silane coupling agent contains an alkoxysilyl group and any one of an amino group, a dicarboxylic acid group, and a dicarboxylic anhydride group.

In another particular aspect of the binder for the lithium secondary battery according to the present invention, the tetracarboxylic anhydride includes a tetracarboxylic anhydride represented by the formula (1) below. The diamine includes a diamine represented by the formula (2) below. The silane coupling agent includes a silane coupling agent represented by the formula (3) below. The polyimide resin includes a structure represented by the formula (4) below. The polyimide resin has an alkoxysilyl group represented by the formula (5) below.

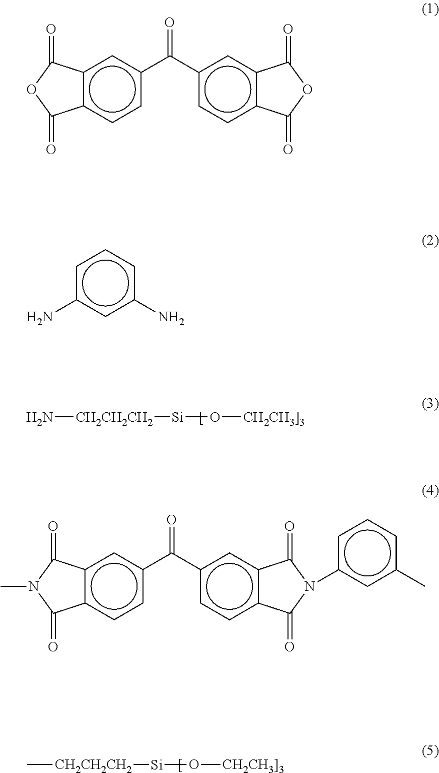

In still another particular aspect of the binder for the lithium secondary battery according to the present invention, the polyimide resin is a resin formed by imidizing a tetracarboxylic acid or a tetracarboxylic anhydride, a diamine, and a silane coupling agent having an amino group. The molar ratio between the tetracarboxylic acid or the tetracarboxylic anhydride and the diamine ((tetracarboxylic acid or tetracarboxylic anhydride):(diamine)) is within the range of 100:100 to 100:95. The molar ratio between the tetracarboxylic acid or the tetracarboxylic anhydride and the silane coupling agent ((tetracarboxylic acid or tetracarboxylic anhydride):(silane coupling agent)) is within the range of 100:2 to 100:10.

In still another particular aspect of the binder for the lithium secondary battery according to the present invention, the polyimide resin is a resin formed by imidizing a tetracarboxylic acid or a tetracarboxylic anhydride, a diamine, and a silane coupling agent having a dicarboxylic acid group or a dicarboxylic anhydride group. The molar ratio between the tetracarboxylic acid or the tetracarboxylic anhydride and the diamine ((tetracarboxylic acid or tetracarboxylic anhydride):(diamine)) is within the range of 95:100 to 100:100. The molar ratio between the diamine and the silane coupling agent ((diamine):(silane coupling agent)) is within the range of 100:2 to 100:10.

A negative electrode for a lithium secondary battery according to the present invention includes a negative-electrode active material layer. The negative-electrode active material layer contains: a product obtained by hydrolyzing the hydrolyzable silyl group in the binder for the lithium secondary battery according to the present invention; and negative-electrode active material particles containing at least one of silicon and a silicon alloy.

A lithium secondary battery according to the present invention includes an electrode assembly and a nonaqueous electrolyte impregnated into the electrode assembly. The electrode assembly includes the above negative electrode for the lithium secondary battery according to the present invention, a positive electrode, and a separator interposed between the negative electrode for the lithium secondary battery and the positive electrode.

A binder precursor solution for a lithium secondary battery according to the present invention contains: an esterified product formed by reaction of a tetracarboxylic acid or a tetracarboxylic anhydride with a monovalent alcohol; a diamine; and a silane coupling agent having a hydrolyzable silyl group and any one of an amino group, a dicarboxylic acid group and a dicarboxylic anhydride group.

In a particular aspect of the binder precursor solution for the lithium secondary battery according to the present invention, the esterified product includes an esterified product formed by reaction of a tetracarboxylic anhydride represented by the formula (1) below with an ethanol serving as the monovalent alcohol. The diamine includes a diamine represented by the formula (2) below. The silane coupling agent includes a silane coupling agent represented by the formula (3) below.

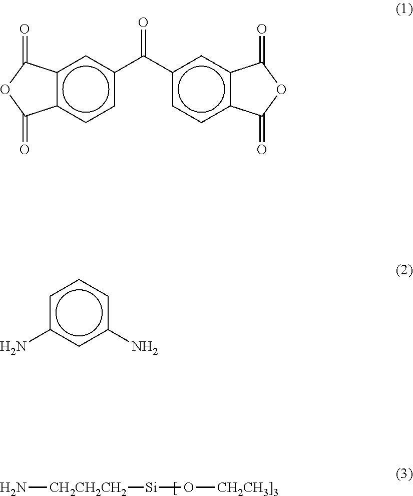

In another particular aspect of the binder precursor solution for the lithium secondary battery according to the present invention, the binder precursor solution contains as the silane coupling agent a silane coupling agent having an amino group. The molar ratio between the tetracarboxylic acid or the tetracarboxylic anhydride and the diamine ((tetracarboxylic acid or tetracarboxylic anhydride):(diamine)) is within the range of 100:100 to 100:95. The molar ratio between the tetracarboxylic acid or the tetracarboxylic anhydride and the silane coupling agent ((tetracarboxylic acid or tetracarboxylic anhydride):(silane coupling agent)) is within the range of 100:2 to 100:10.

In another particular aspect of the binder precursor solution for the lithium secondary battery according to the present invention, the binder precursor solution contains as the silane coupling agent a silane coupling agent having a dicarboxylic acid group or a dicarboxylic anhydride group. The molar ratio between the tetracarboxylic acid or the tetracarboxylic anhydride and the diamine ((tetracarboxylic acid or tetracarboxylic anhydride):(diamine)) is within the range of 95:100 to 100:100. The molar ratio between the diamine and the silane coupling agent ((diamine):(silane coupling agent)) is within the range of 100:2 to 100:10.

In a method for manufacturing a negative electrode for a lithium secondary battery according to the present invention, the binder precursor solution for the lithium secondary battery according to the present invention is prepared. A negative-electrode active material slurry is prepared by dispersing negative-electrode active material particles containing at least one of silicon and a silicon alloy into the binder precursor solution for the lithium secondary battery. The negative-electrode active material slurry is applied onto a negative-electrode current collector. A negative-electrode active material layer is formed on the negative-electrode current collector by subjecting the negative-electrode current collector having the negative-electrode active material slurry applied thereon to a heat treatment in a non-oxidizing atmosphere to imidize the esterified product, the diamine, and the silane coupling agent.

The present invention can provide a binder capable of realizing a lithium secondary battery that includes a negative electrode including a negative-electrode active material layer containing at least one of silicon and a silicon alloy as a negative-electrode active material and also containing a binder and has an excellent charge-discharge cycle characteristic.

### BRIEF DESCRIPTION OF DRAWINGS

FIG. 1 is a schematic cross-sectional view of a lithium secondary battery according to an embodiment of the present invention.

FIG. 2 is a schematic plan view of the lithium secondary battery according to the above embodiment of the present invention.

FIG. 3 is a schematic perspective view of an electrode assembly in the above embodiment of the present invention.

FIG. 4 is a schematic cross-sectional view of part of a negative electrode in the above embodiment of the present invention.

### DETAILED DESCRIPTION

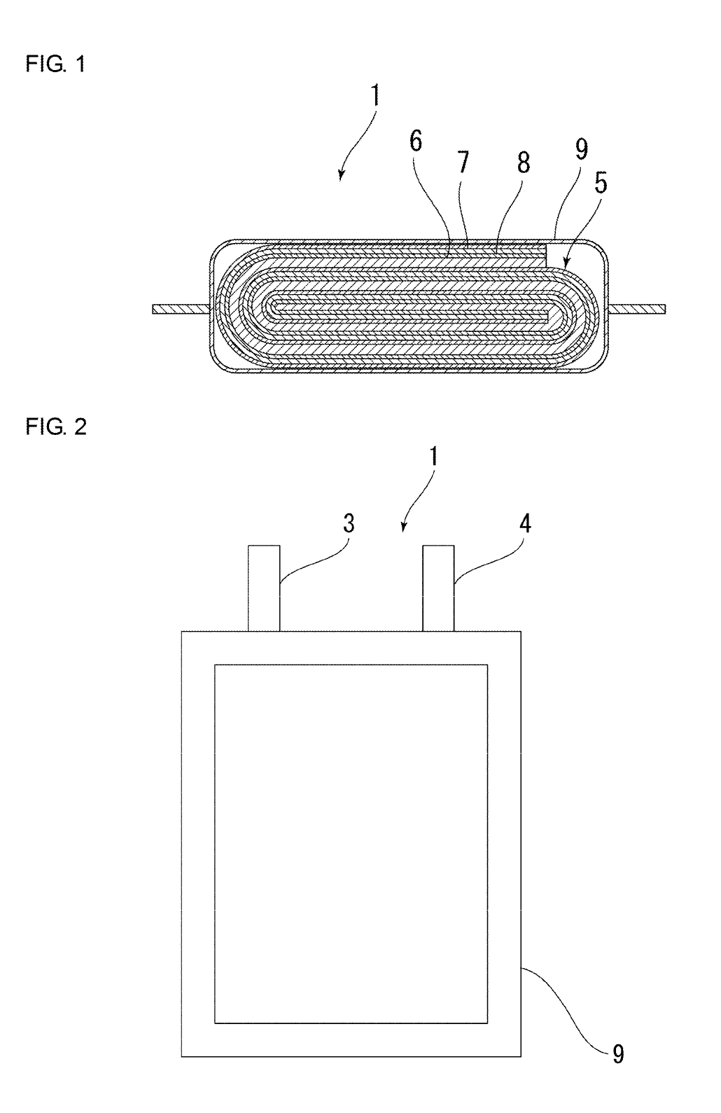

Hereinafter, a preferred embodiment of the present invention will be described taking as an example a lithium secondary battery 1 shown in FIGS. 1 and 2. Note that the lithium secondary battery 1 is illustrative only. The present invention is not at all limited to the lithium secondary battery 1.

As shown in FIG. 1, the lithium secondary battery 1 includes a flat electrode assembly 5. The electrode assembly 5 is housed in a spirally wound form in an outer casing 9. The outer casing 9 can be made of, for example, metal, alloy, or resin.

The electrode assembly 5 is impregnated with a nonaqueous electrolyte. Specific examples of the solvent for use in the nonaqueous electrolyte include cyclic carbonates, such as ethylene carbonate, propylene carbonate, butylene carbonate, and fluoroethylene carbonate; chain carbonates, such as dimethyl carbonate, methyl ethyl carbonate, and diethyl carbonate; and mixture solvents of a cyclic carbonate and a chain carbonate.

Specific examples of the solute for use in the nonaqueous electrolyte include LiPF₆, LiBF₄, LiCF₃SO₃, LiN(CF₃SO₂)₂, LiN(C₂F₅SO₂)₂, LiN(CF₃SO₂) (C₄F₉SO₂), LiC(CF₃SO₂)₃, LiC(C₂F₅SO₂)₃, and mixtures of them.

Usable nonaqueous electrolytes include gel polymer electrolytes in which a polymer electrolyte, such as polyethylene oxide or polyacrylonitrile, is impregnated with an electrolytic solution, and inorganic solid electrolytes, such as LiI and Li₃N.

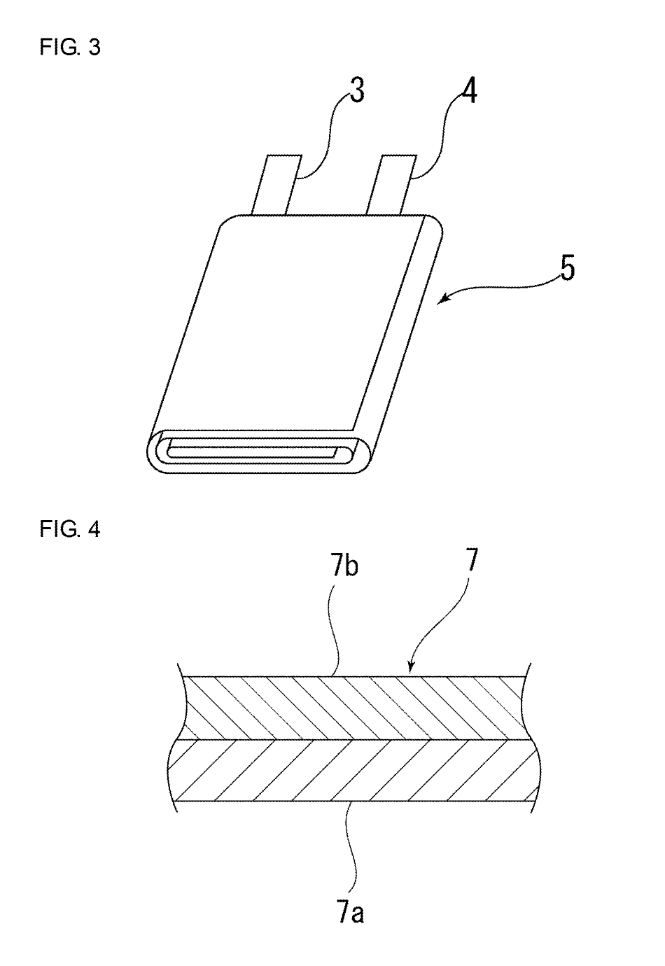

As shown in FIG. 1, the electrode assembly 5 includes a negative electrode 7 electrically connected with a negative-electrode current collector tab 4 (see FIGS. 2 and 3), a positive electrode 6 electrically connected with a positive-electrode current collector tab 3 (see FIGS. 2 and 3), and separators 8. The separators 8 are interposed one between each pair of adjacent sides of the negative electrode 7 and the positive electrode 6. The separators 8 electrically insulate the negative electrode 7 from the positive electrode 6.

The positive electrode 6 includes a positive-electrode current collector composed such as of a piece of electrically conductive metal foil; and a positive-electrode active material layer formed on the positive-electrode current collector. The positive-electrode active material layer contains a positive-electrode active material. No particular limitation is placed on the positive-electrode active material, so long as lithium can be electrochemically inserted into and extracted from it. Specific examples of the positive-electrode active material include lithium-containing transition metal oxides, such as LiCoO₂, LiNiO₂, LiMn₂O₄, LiMnO₂, LiCO_{0.5}Ni_{0.5}O₂, and LiNi_{0.7}CO_{0.2}Mn_{0.1}O₂; and metal oxides containing no lithium, such as MnO₂.

As shown in FIG. 4, the negative electrode 7 includes a negative-electrode current collector 7a and a negative-electrode active material layer 7b. No particular limitation is placed on the material of the negative-electrode current collector 7a, so long as it has electrical conductivity. The negative-electrode current collector can be composed of a piece of electrically conductive metal foil, for example. Specific examples of electrically conductive metal foils include foils made of metals, such as copper, nickel, iron, titan, cobalt, manganese, tin, silicon, chrome, and zirconium; and foils made of alloys containing one or more of these metals. Preferred among them are copper thin film and foils made of alloys containing copper because it is preferred that the electrically conductive metal foil contain a metal element likely be dispersed into active material particles.

The negative-electrode active material layer 7b is formed on the negative-electrode current collector 7a. The negative-electrode active material layer 7b contains negative-electrode active material particles and a binder. The negative-electrode active material layer 7b may further contain an electronic conductor, such as acetylene black.

In this embodiment, the negative-electrode active material particles contain as a negative-electrode active material at least one of silicon and a silicon alloy.

In this embodiment, the binder contains a polyimide resin that is formed by imidizing a diamine and a tetracarboxylic acid or a tetracarboxylic anhydride and has a hydrolyzable silyl group. Therefore, the binder contains silanol groups into which hydrolyzable silyl groups are hydrolyzed. Then, the silanol groups undergo a dehydrocondensation reaction with hydroxyl groups existing in the surfaces of the negative-electrode active material particles, so that a chemical bond is formed between the binder and the negative-electrode active material particles. This achieves a strong bonding between the binder and the negative-electrode active material. Therefore, even if a volume change in the negative-electrode active material occurs during charge and discharge, the binder is less likely to be separated from the negative-electrode active material particles. Hence, a resultant lithium secondary battery achieves an excellent charge-discharge cycle characteristic.

No particular limitation is placed on the type of the hydrolyzable silyl group for use, so long as it can be hydrolyzed by reaction with moisture in the air. The hydrolyzable silyl group may be an alkoxysilyl group, for example. A specific example of the alkoxysilyl group is as represented by the following chemical formula (5):

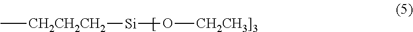

No particular limitation is placed on the method for producing the polyimide resin having a hydrolyzable silyi group. For example, the polyimide resin having a hydrolyzable silyl group can be formed by imidizing a tetracarboxylic acid or a tetracarboxylic anhydride; a diamine; and a silane coupling agent containing an alkoxysilyl group and any one of an amino group, a dicarboxylic acid group and a dicarboxylic anhydride group.

A specific example of the tetracarboxylic anhydride is a tetracarboxylic anhydride represented by the formula (1) below.

A specific example of the diamine is a diamine represented by the formula (2) below.

A specific example of the silane coupling agent is a silane coupling agent represented by the formula (3) below.

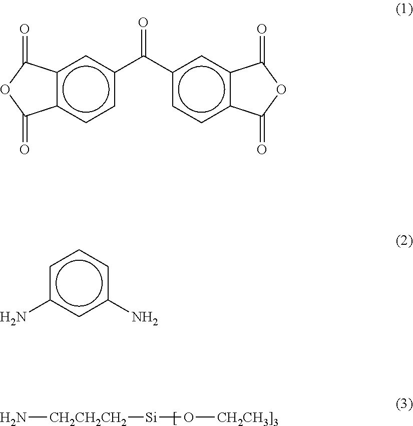

The polyimide resin when produced by imidizing the tetracarboxylic anhydride represented by the above formula (1), the diamine represented by the above formula (2), and the silane coupling agent represented by the above formula (3) is a polyimide resin which has a structure represented by the formula (4) below in its main backbone and also has an alkoxysilyl group represented by the above formula (5). This polyimide resin contains many aromatic rings in the main backbone. Therefore, this polyimide resin has high mechanical strength. Thus, with the use of a binder containing the above polyimide resin, peeling of the negative-electrode active material layer 7b from the negative-electrode current collector 7a can be effectively prevented. Hence, a resultant lithium secondary battery can achieve a more excellent charge-discharge cycle characteristic.

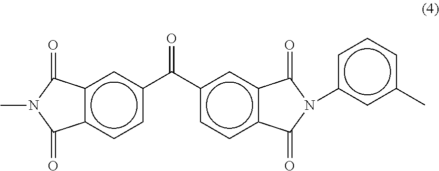

However, the types of the tetracarboxylic anhydride, the diamine, and the silane coupling agent are not limited to the above specific examples. Examples of the preferred tetracarboxylic anhydride, diamine, and silane coupling agent other than the above specific examples are as follows.

Specific examples of the tetracarboxylic anhydride include aromatic tetracarboxylic dianhydrides, such as 1,2,4,5-benzenetetracarboxylic 1,2:4,5-dianhydride (also known as pyromellitic dianhydride), 3,3′,4,4′-biphenyltetracarboxylic dianhydride, 3,3′,4,4′-diphenylsulfonetetracarboxylic dianhydride, 3,3′,4,4′-diphenylethertetracarboxylic dianhydride, and 3,3′,4,4′-diphenylmethanetetracarboxylic dianhydride.

Specific examples of the diamine include aromatic diamines, such as p-phenylenediamine, 3,3′-diaminobenzophenone, 4,4′-diaminobiphenyl, 4,4′-diaminodiphenylsulfone, 4,4′-diaminophenylether, 4,4′-diaminophenylmethane, 2,2-bis[4(4-aminophenoxy)phenyl]propane, 1,4-bis(3-aminophenoxy)benzene, and 1,4-bis(4-aminophenoxy)benzene.

Examples of the silane coupling agent include those having an amino group, such as the silane coupling agent represented by the above formula (3), and those having a dicarboxylic acid group or a dicarboxylic anhydride group. The silane coupling agent having an amino group forms an imide bond with a tetracarboxylic acid or a tetracarboxylic anhydride. On the other hand, the silane coupling agent having a dicarboxylic acid group or a dicarboxylic anhydride group forms an imide bond with a diamine.

Specific examples of the silane coupling agent having an amino group include N-β(aminoethyl) γ-aminopropyl trimethoxy silane; N-β(aminoethyl) γ-aminopropyl methyl dimethoxy silane; N-β(aminoethyl) γ-aminopropyl triethoxy silane, N-β(aminoethyl) γ-aminopropyl methyl diethoxy silane; γ-aminopropyl trimethoxy silane; γ-aminopropyl methyl dimethoxy silane; and γ-aminopropyl methyl diethoxy silane.

Specific examples of the silane coupling agent having a dicarboxylic acid group or a dicarboxylic anhydride group include silane coupling agents represented by the following formulae (6) to (21).

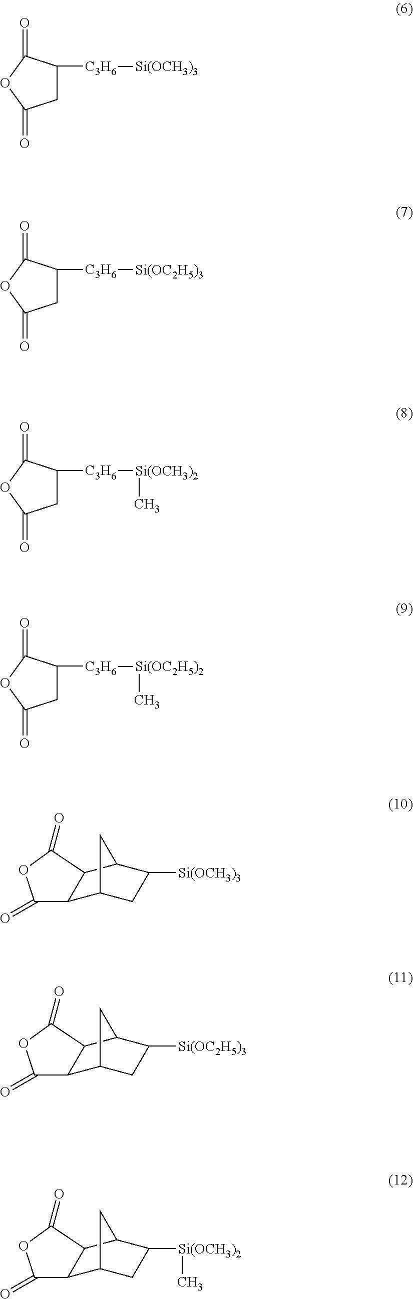

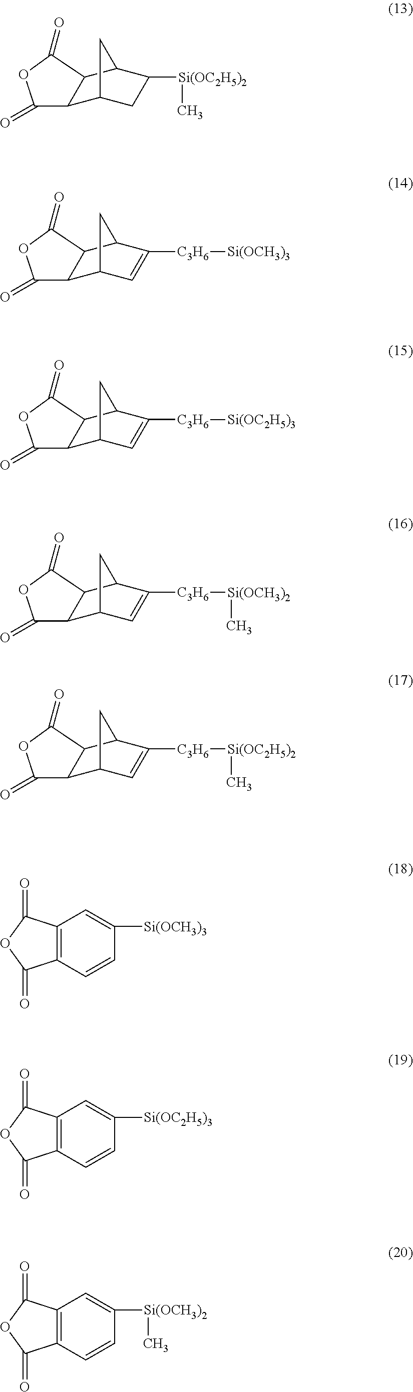

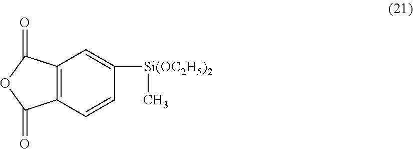

With the use of a silane coupling agent having a single amino group, the molar ratio between the tetracarboxylic acid or the tetracarboxylic anhydride and the diamine ((tetracarboxylic acid or tetracarboxylic anhydride):(diamine)) is preferably within the range of 100:100 to 100:95. The molar ratio between the tetracarboxylic acid or the tetracarboxylic anhydride and the silane coupling agent ((tetracarboxylic acid or tetracarboxylic anhydride):(silane coupling agent)) is preferably within the range of 100:2 to 100:10. In this case, the degree of bonding between the binder and the negative-electrode active material particles can be effectively increased without significant impairment in the mechanical strength of the binder.

If the molar ratio between the tetracarboxylic acid or the tetracarboxylic anhydride and the diamine is out of the above range, the degree of polymerization becomes excessively low, which may excessively decrease the mechanical strength of the binder.

If the molar ratio of the silane coupling agent to the tetracarboxylic acid or the tetracarboxylic anhydride is too low, the effect of increasing the degree of bonding between the binder and the negative-electrode active material particles may not sufficiently be obtained. On the other hand, if the molar ratio of the silane coupling agent to the tetracarboxylic acid or the tetracarboxylic anhydride is too large, the degree of polymerization of the binder becomes excessively low, which may excessively decrease the mechanical strength of the binder.

With the use of a silane coupling agent having a single dicarboxylic acid group or dicarboxylic anhydride group, the molar ratio between the tetracarboxylic acid or the tetracarboxylic anhydride and the diamine ((tetracarboxylic acid or tetracarboxylic anhydride):(diamine)) is preferably within the range of 95:100 to 100:100. In addition, the molar ratio between the diamine and the silane coupling agent ((diamine):(silane coupling agent)) is preferably within the range of 100:2 to 100:10. In this case, the degree of bonding between the binder and the negative-electrode active material particles can be effectively increased without significant impairment in the mechanical strength of the binder.

If the molar ratio between the tetracarboxylic acid or the tetracarboxylic anhydride and the diamine is out of the above range, the degree of polymerization becomes excessively low, which may excessively decrease the mechanical strength of the binder.

If the molar ratio of the silane coupling agent to the diamine is too low, the effect of increasing the degree of bonding between the binder and the negative-electrode active material particles may not sufficiently be obtained. On the other hand, if the molar ratio of the silane coupling agent to the diamine is too large, the degree of polymerization of the binder becomes excessively low, which may excessively decrease the mechanical strength of the binder.

A description is given next to an example of a method for manufacturing the lithium secondary battery 1 according to this embodiment.

First prepared is a binder precursor solution containing: an esterified product formed by reaction of a tetracarboxylic acid or a tetracarboxylic anhydride with a monovalent alcohol; a diamine; and a silane coupling agent having a hydrolyzable silyl group.

Usable tetracarboxylic acids or tetracarboxylic anhydrides, diamines, and silane coupling agents in this method are those described above.

Specific examples of the monovalent alcohol include aliphatic alcohols, such as methanol, ethanol, isopropanol, butanol, ethyl cellosolve, butyl cellosolve, propylene glycol ethyl ether, and ethyl carbitol; and cyclic alcohols, such as benzyl alcohol and cyclohexanol.

With the use of a silane coupling agent having an amino group, the molar ratio between the tetracarboxylic acid or the tetracarboxylic anhydride and the diamine ((tetracarboxylic acid or tetracarboxylic anhydride):(diamine)) in the binder precursor solution is preferably within the range of 100:100 to 100:95. In addition, the molar ratio between the tetracarboxylic acid or the tetracarboxylic anhydride and the silane coupling agent ((tetracarboxylic acid or tetracarboxylic anhydride):(silane coupling agent)) is preferably within the range of 100:2 to 100:10.

On the other hand, with the use of a silane coupling agent having a dicarboxylic acid group or a dicarboxylic anhydride group, the molar ratio between the tetracarboxylic acid or the tetracarboxylic anhydride and the diamine ((tetracarboxylic acid or tetracarboxylic anhydride):(diamine)) in the binder precursor solution is preferably within the range of 95:100 to 100:100. In addition, the molar ratio between the diamine and the silane coupling agent ((diamine):(silane coupling agent)) is preferably within the range of 100:2 to 100:10.

Next, a negative-electrode active material slurry is prepared by dispersing negative-electrode active material particles containing at least one of silicon and a silicon alloy into the binder precursor solution. The negative-electrode active material slurry is applied onto a negative-electrode current collector 7a. Thereafter, the negative-electrode current collector 7a having the negative-electrode active material slurry applied thereon is subjected to a heat treatment in a non-oxidizing atmosphere to imidize the esterified product, the diamine, and the silane coupling agent, so that a negative-electrode active material layer 7b is formed on the negative-electrode current collector 7a.

A resultant negative electrode 7 produced in the above manner and a positive electrode 6 are rolled up with separators 8 interposed one between each pair of adjacent sides of both electrodes 6 and 7 to produce an electrode assembly 5. Next, the electrode assembly 5 is impregnated with a nonaqueous electrolyte and housed in an outer casing 9. Thereafter, the opening of the outer casing 9 is sealed to complete a lithium secondary battery 1.

In the above manufacturing method, the binder precursor solution containing a monomer component of a polyimide resin, used for the formation of the negative-electrode active material layer, has a lower viscosity than binder precursors in polymer form commonly used as precursors to polyimide resins, such as polyamic acids. Therefore, through the use of a binder precursor solution containing a monomer component of a polyimide resin, the binder precursor solution is likely to enter between asperities on the surfaces of the negative-electrode active material particles during preparation of the negative-electrode active material slurry. Furthermore, the binder precursor solution is also likely to enter between asperities on the surfaces of the negative-electrode current collector during application of the negative-electrode active material slurry onto the negative-electrode current collector. Thus, the anchoring effect between the negative-electrode active material particles and the anchoring effect between the negative-electrode active material particles and the negative-electrode current collector are largely developed. Therefore, the degree of adhesion between the negative-electrode active material layer and the negative-electrode current collector can be further increased.

The temperature during the heat treatment in the non-oxidizing atmosphere is preferably within the range of temperatures above the glass transition temperature of the polyimide resin and below the 5% weight loss temperature thereof. When the heat treatment is conducted at a temperature above the glass transition temperature, the polyimide resin produced has plasticity. This further increases the entrance of the binder between asperities existing on the surfaces of the negative-electrode active material particles and the surface of the negative-electrode current collector 7a, so that the anchoring effect is more largely developed. Therefore, the degree of bonding between the binder and the negative-electrode active material particles and the degree of adhesion between the binder and the negative-electrode current collector 7a can be further increased.

Hereinafter, the present invention will be described in more detail with reference to specific examples. However, the present invention is not limited at all by the following examples and can be embodied in various other forms appropriately modified without changing the spirit of the invention.

### Example 1

In Example 1, a battery A1 having a substantially similar structure to the lithium secondary battery 1 according to the above embodiment was produced in the following manner.

[Production of Negative Electrode]

(1) Preparation of Negative-Electrode Active Material

First, fine polycrystalline silicon particles were introduced into a fluidized bed having an internal temperature of 800° C., and monosilane (SiH₄) was fed into it to prepare particulate polycrystalline silicon. Next, this particulate polycrystalline silicon was ground using a jet mill, and the ground polycrystalline silicon particles were then classified by a classifier to prepare polycrystalline silicon powder (serving as a negative electrode active material). The median diameter of the polycrystalline silicon powder was 10 μm. The crystallite size of the polycrystalline silicon powder was 44 nm.

The median diameter refers to a diameter at 50% cumulative volume in a particle size distribution measurement made by laser diffractometry. The crystallite size was calculated from the Scherrer equation using the peak half-width of the silicon (111) plane obtained by powder X-ray diffractometry.

(2) Preparation of Binder Precursor Solution

First, 3,3′,4,4′-benzophenonetetracarboxylic dianhydride represented by the above formula (1) was reacted with 2 equivalent of ethanol to prepare an esterified product of 3,3′,4,4′-benzophenonetetracarboxylic dianhydride. Next, the esterified product, m-phenylenediamine represented by the above formula (2), and 3-aminopropyl triethoxy silane represented by the above formula (3) were dissolved in N-methyl-2-pyrrolidone (NMP) to prepare a binder precursor solution a1. The (3,3′,4,4′-benzophenonetetracarboxylic dianhydride):(m-phenylenediamine):(3-aminopropyl triethoxy silane) molar ratio was 100:95:10.

(3) Preparation of Negative-Electrode Active Material Slurry

The prepared negative-electrode active material powder, graphite powder having an average particle size of 3 μm as a negative-electrode electronic conductor, and the binder precursor solution a1 were mixed together to prepare a negative-electrode active material slurry. The mass ratio of the negative-electrode active material powder to the graphite powder to the negative electrode binder (binder subjected to NMP removal by drying the negative-electrode binder precursor solutional, a polymerization reaction, and an imidization reaction) was 97:3:8.6.

(4) Production of Negative Electrode

Both sides of a piece of 18 μm thick copper alloy foil were roughened by electrolytic copper plating to have a surface roughness Ra (defined by Japanese Industrial Standard (JIS) B 0601-2001) of 0.25 μm and an average peak-to-peak distance S (defined by JIS B 0601-2001) of 0.85 μm. The resultant piece of copper alloy foil was used as a negative-electrode current collector.

The prepared negative-electrode active material slurry was applied onto both sides of the negative-electrode current collector in an air atmosphere at 25° C., then dried in an air atmosphere at 120° C., and then rolled in an air atmosphere at 25° C. Thereafter, the negative electrode current collector was subjected to a heat treatment in an argon atmosphere at 400° C. for 10 hours. Thus, a negative electrode was produced in which a pair of negative-electrode active material layers were formed one on each side of the negative-electrode current collector.

Finally, a nickel plate was connected as a negative-electrode current collector tab to an end of the negative electrode.

In order to confirm that a polyimide resin was produced from the binder precursor solutional by the heat treatment, the following experiment was conducted. First, the binder precursor solutional was dried in an air atmosphere at 120° C. to remove NMP and then subjected to a heat treatment in an argon atmosphere at 400° C. for 10 hours in the same manner as in the foregoing heat treatment. The resultant product was analyzed for infrared (IR) absorption spectrum. As a result, a peak from an imide bond was observed in the vicinity of 1720 cm⁻¹. Thus, it was confirmed that due to the heat treatment of the binder precursor solutional, the polymerization reaction and the imidization reaction progressed to produce a polyimide compound.

[Production of Positive Electrode]

(1) Preparation of Lithium-Transition Metal Composite Oxide

Li₂CO₃ and CoCO₃ were mixed in a mortar to given a Li to Co molar ratio of 1:1. The mixture was subjected to a heat treatment in an air atmosphere at 800° C. for 24 hours and then ground. Thus, a lithium-cobalt composite oxide represented as LiCoO₂ was obtained in the form of powder having an average particle size of 11 μm. In this example, the lithium-cobalt composite oxide powder was used as a positive-electrode active material powder.

The resultant positive-electrode active material powder had a BET specific surface area of 0.37 m²/g.

(2) Production of Positive Electrode

The above prepared positive-electrode active material powder, carbon material powder as a positive-electrode electronic conductor, and poly(vinylidene fluoride) as a positive electrode binder were added to N-methyl-2-pyrrolidone as a dispersion medium and then kneaded to prepare a positive-electrode active material slurry. The preparation was adjusted so that the mass ratio of the positive-electrode active material powder to the positive-electrode electronic conductor to the positive electrode binder was 95:2.5:2.5.

The positive-electrode active material slurry was applied onto both sides of a 15 μm thick piece of aluminum foil serving as a positive-electrode current collector, dried, and then rolled.

Finally, an aluminum plate was connected as a positive-electrode current collector tab to an unapplied portion of the positive-electrode active material layer of the positive-electrode current collector.

[Preparation of Nonaqueous Electrolytic Solution]

In an argon atmosphere, lithium hexafluorophosphate (LiPF₆) was dissolved in a mixed solvent containing ethylene carbonate (EC) and diethyl carbonate (DEC) in a volume ratio of 3:7 to reach a concentration of 1 mol/L, thereby preparing a nonaqueous electrolytic solution.

[Production of Electrode Assembly]

Prepared were a single sheet of the above positive electrode, a single sheet of the above negative electrode, and two sheets of separator made of microporous polyethylene membrane. The positive electrode, the negative electrode, and the separators were spirally wound up, one separator interposed between each pair of adjacent sides of both electrodes, on a columnar winding core so that both the positive-electrode current collector tab and the negative-electrode current collector tab were located at the outermost turn. Thereafter, the winding core was pulled out to produce a spirally wound electrode assembly. Subsequently, the electrode assembly was pressed down to give it the final form.

[Production of Battery]

The above produced flat electrode assembly and the above prepared electrolytic solution were put into an outer casing made of aluminum laminate in an argon atmosphere at 25° C. and at 1 atmospheric pressure to prepare a flat battery A1 of Example 1.

### Example 2

A battery A2 was produced in the same manner as in Example 1 except that in preparing a binder precursor solution, the (3,3′,4,4′-benzophenonetetracarboxylic dianhydride):(m-phenylenediamine):(3-aminopropyl triethoxy silane) molar ratio was 100:100:5.

### Comparative Example 1

A battery B1 was produced in the same manner as in Example 1 except that N-phenyl-3-aminopropyl trimethoxy silane represented by the following formula (22) was used instead of 3-aminopropyl triethoxy silane.

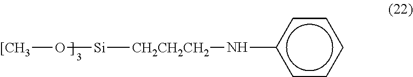

### Comparative Example 2

A battery B2 was produced in the same manner as in Example 1 except that in preparing a binder precursor solution, the (3,3′,4,4′-benzophenonetetracarboxylic dianhydride):(m-phenylenediamine):(3-aminopropyl triethoxy silane) molar ratio was 100:100:0. In other words, in Comparative Example 2, no alkoxysilyl group was introduced into the polyimide resin serving as a binder.

[Evaluation of Charge-Discharge Cycle Characteristic]

The batteries A1, A2, B1, and B2 were evaluated for charge-discharge cycle characteristic under the following charge-discharge cycle conditions.

(Charge-Discharge Cycle Conditions)

Charge Conditions in First Cycle

Each battery was charged at a constant current of 50 mA for 4 hours, then charged at a constant current of 200 mA to a battery voltage of 4.2 V, and then further charged at a constant voltage of 4.2 V to a current value of 50 mA.

Discharge Conditions in First Cycle

Each battery was discharged at a constant current of 200 mA to a battery voltage of 2.75 V.

Charge Conditions in Second and Subsequent Cycles

Each battery was charged at a constant current of 1000 mA to a battery voltage of 4.2 V and then further charged at a constant voltage of 4.2 V to a current value of 50 mA.

Discharge Conditions in Second and Subsequent Cycles

Each battery was discharged at a constant current of 1000 mA to a battery voltage of 2.75 V.

Next, the initial charge/discharge efficiency and the cycle life were determined based on the following calculation methods. The results are shown in TABLE 1.

Initial charge/discharge efficiency={(1st cycle discharge capacity)/(1st cycle charge capacity)}×100

Cycle life: The number of cycles when the capacity retention reaches 70%

The capacity retention is a value obtained by dividing the n-th cycle discharge capacity by the first cycle discharge capacity.

TABLE 1

| | Negative Electrode Binder | | | | | | Charge-Discharge Cycle | |
|---|---|---|---|---|---|---|---|---|
| | Tetracarboxylic | | | | Silane Coupling | | Characteristic | |
| | Dianhydride | | Diamine | | Agent | | Initial Charge/ | |
| | | Molar | | Molar | | Molar | Discharge | Cycle |
| Battery | Structure | Ratio | Structure | Ratio | Structure | Ratio | Efficiency (%) | Life |
| Battery A1 | Formula (1) | 100 | Formula (2) | 95 | Formula (3) | 10 | 88 | 360 |
| Battery A2 | Formula (1) | 100 | Formula (2) | 100 | Formula (3) | 5 | 88 | 329 |
| Battery B1 | Formula (1) | 100 | Formula (2) | 95 | Formula (22) | 10 | 88 | 282 |
| Battery B2 | Formula (1) | 100 | Formula (2) | 100 | Formula (3) | 0 | 88 | 290 |

The results shown in TABLE 1 reveals that the batteries A1 and A2, containing a polyimide resin having a hydrolyzable silyl group as a negative electrode binder, have better charge-discharge cycle characteristics than the batteries B1 and B2, containing a polyimide resin having no hydrolyzable silyl group as a negative electrode binder.

Furthermore, comparison between the batteries A1 and A2 reveals that the battery A1, in which the content of 3,3′,4,4′-benzophenonetetracarboxylic dianhydride is larger than that of m-phenylenediamine, has a more excellent charge-discharge cycle characteristic than the battery A2, containing equimolar amounts of 3,3′,4,4′-benzophenonetetracarboxylic dianhydride and m-phenylenediamine. The reason for this can be that an excessive addition of 3,3′,4,4′-benzophenonetetracarboxylic dianhydride to be reacted with 3-aminopropyl triethoxy silane serving as a silane coupling agent allowed induction of a larger amount of alkoxysilyl group.

What is claimed is:

1. A binder for a lithium secondary battery, the binder containing a polyimide resin formed by imidizing either a tetracarboxylic acid or a tetracarboxylic anhydride and a diamine, the polyimide resin having a hydrolyzable silyl group.

2. The binder for the lithium secondary battery according to claim 1, wherein the hydrolyzable silyl group is an alkoxysilyl group.

3. The binder for the lithium secondary battery according to claim 1, wherein
the polyimide resin is a resin formed by imidizing a tetracarboxylic anhydride, a diamine, and a silane coupling agent, and
the silane coupling agent contains an alkoxysilyl group and any one of an amino group, a dicarboxylic acid group, and a dicarboxylic anhydride group.

4. The binder for the lithium secondary battery, according to claim 3, wherein
the tetracarboxylic anhydride includes a tetracarboxylic anhydride represented by the formula (1) below,
the diamine includes a diamine represented by the formula (2) below,
the silane coupling agent includes a silane coupling agent represented by the formula (3) below, and
the polyimide resin includes a structure represented by the formula (4) below and has an alkoxysilyl group represented by the formula (5) below.

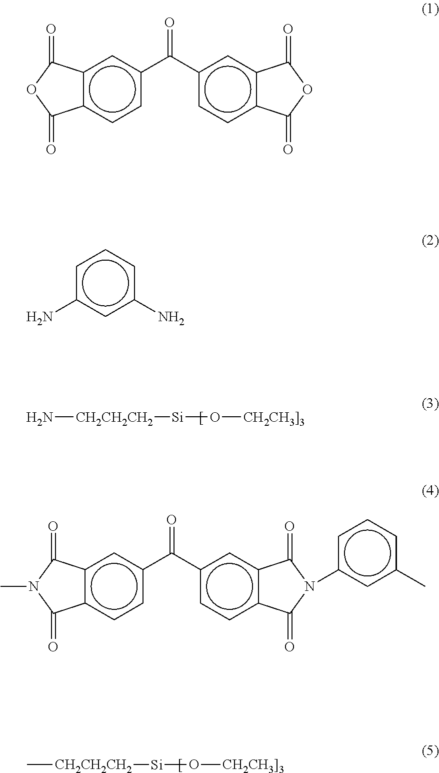

5. The binder for the lithium secondary battery according to claim 1, wherein
the polyimide resin is a resin formed by imidizing a tetracarboxylic acid or a tetracarboxylic anhydride, a diamine, and a silane coupling agent having an amino group,
the molar ratio between the tetracarboxylic acid or the tetracarboxylic anhydride and the diamine ((tetracarboxylic acid or tetracarboxylic anhydride):(diamine)) is within the range of 100:100 to 100:95, and
the molar ratio between the tetracarboxylic acid or the tetracarboxylic anhydride and the silane coupling agent ((tetracarboxylic acid or tetracarboxylic anhydride):(silane coupling agent)) is within the range of 100:2 to 100:10.

6. The binder for the lithium secondary battery according to claim 1, wherein
the polyimide resin is a resin formed by imidizing a tetracarboxylic acid or a tetracarboxylic anhydride, a diamine, and a silane coupling agent having a dicarboxylic acid group or a dicarboxylic anhydride group,
the molar ratio between the tetracarboxylic acid or the tetracarboxylic anhydride and the diamine ((tetracarboxylic acid or tetracarboxylic anhydride):(diamine)) is within the range of 95:100 to 100:100, and
the molar ratio between the diamine and the silane coupling agent ((diamine):(silane coupling agent)) is within the range of 100:2 to 100:10.

7. A negative electrode for a lithium secondary battery, comprising a negative-electrode active material layer containing: a product obtained by hydrolyzing the hydrolyzable silyl group in the binder for the lithium secondary battery according to claim 1; and negative-electrode active material particles containing at least one of silicon and a silicon alloy.

8. A lithium secondary battery comprising:
an electrode assembly including the negative electrode for the lithium secondary battery according to claim 7, a positive electrode, and a separator interposed between the negative electrode for the lithium secondary battery and the positive electrode; and
a nonaqueous electrolyte impregnated into the electrode assembly.

9. A binder precursor solution for a lithium secondary battery, containing: an esterified product formed by reaction of a tetracarboxylic acid or a tetracarboxylic anhydride with a monovalent alcohol; a diamine; and a silane coupling agent having a hydrolyzable silyl group and any one of an amino group, a dicarboxylic acid group, and a dicarboxylic anhydride group.

10. The binder precursor solution for the lithium secondary battery according to claim 9, wherein
the esterified product includes an esterified product formed by reaction of a tetracarboxylic anhydride represented by the formula (1) below with an ethanol serving as the monovalent alcohol,
the diamine includes a diamine represented by the formula (2) below, and
the silane coupling agent includes a silane coupling agent represented by the formula (3) below.

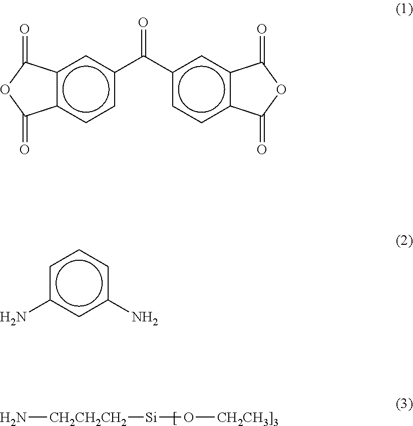

11. The binder precursor solution for the lithium secondary battery according to claim 9, wherein
the binder precursor solution contains as the silane coupling agent a silane coupling agent having an amino group,
the molar ratio between the tetracarboxylic acid or the tetracarboxylic anhydride and the diamine ((tetracarboxylic acid or tetracarboxylic anhydride):(diamine)) is within the range of 100:100 to 100:95, and
the molar ratio between the tetracarboxylic acid or the tetracarboxylic anhydride and the silane coupling agent ((tetracarboxylic acid or tetracarboxylic anhydride):(silane coupling agent)) is within the range of 100:2 to 100:10.

12. The binder precursor solution for the lithium secondary battery according to claim 9, wherein
the binder precursor solution contains as the silane coupling agent a silane coupling agent having a dicarboxylic acid group or a dicarboxylic anhydride group,
the molar ratio between the tetracarboxylic acid or the tetracarboxylic anhydride and the diamine ((tetracarboxylic acid or tetracarboxylic anhydride):(diamine)) is within the range of 95:100 to 100:100, and
the molar ratio between the diamine and the silane coupling agent ((diamine):(silane coupling agent)) is within the range of 100:2 to 100:10.

13. A method for manufacturing a negative electrode for a lithium secondary battery, the method comprising the steps of:
preparing the binder precursor solution for the lithium secondary battery according to claim 9;
preparing a negative-electrode active material slurry by dispersing negative-electrode active material particles containing at least one of silicon and a silicon alloy into the binder precursor solution for the lithium secondary battery;
applying the negative-electrode active material slurry onto a negative-electrode current collector; and
forming a negative-electrode active material layer on the negative-electrode current collector by subjecting the negative-electrode current collector having the negative-electrode active material slurry applied thereon to a heat treatment in a non-oxidizing atmosphere to imidize the esterified product, the diamine, and the silane coupling agent.
